(19) United States
(12) Patent Application Publication
(10) Pub. No.: US 2010/0034932 A1
(43) Pub. Date: Feb. 11, 2010

(54) Edible food casing based on proteins, and process for production thereof

(76) Inventors: Michael SCHMIDT, Oestrich-Winkel (DE); Stefanie Stalberg, Taunusstein (DE); Marion Bueker, Singhofen (DE); Gert Bueker, Singhofen (DE)

Correspondence Address: PROPAT, L.L.C., 425-C SOUTH SHARON AMITY ROAD, CHARLOTTE, NC, 28211-2841, US

(21) Appl. No.: 12/536,548

(22) Filed: Aug. 6, 2009

(30) Foreign Application Priority Data
Aug. 7, 2008 (DE) 10 2008 036 850.4

(51) Int. Cl. A22C 13/00; A23L 1/317; A22C 11/00; A23P 1/12

(52) U.S. Cl. 426/105; 426/138; 426/277; 426/140

(57) ABSTRACT

An edible food casing, i.e. a casing which can also be consumed, is disclosed which is based on non-heat-coagulating protein which is mixed with a heat-coagulating agent. The non-heat-coagulating protein is preferably collagen and/or a collagen derivative, whereas the heat-coagulating agent is preferably protein from hens' eggs, blood plasma, whey isolate, globin and/or myosin. The casing can be produced as a flat film. It can also be generated immediately in the production of the food product, in particular in sausage production, using a coextrusion ring die around an extruded food. The casing is solidified by treatment with an aqueous salt solution, if appropriate also using transaminase. The food product is preferably a bratwurst.

### CROSS-REFERENCE TO RELATED APPLICATIONS

This application claims priority to German Patent Application No. 10 2008 036 850.4 filed Aug. 7, 2008 which is hereby incorporated herein by reference in its entirety.

### FIELD OF THE INVENTION

The invention relates to an edible food casing based on a non-heat-coagulating protein, a process for production thereof, a food product which comprises this casing, and also a process for producing the food product.

### BACKGROUND OF THE INVENTION

In the production of bratwurst, to date natural skins are virtually exclusively used, in particular from the small intestine of sheep (sheep gut skins) or cattle, in particular Cebu cattle. These originate predominantly from South America (Brazil, Argentina). On account of animal epidemics such as Kreutzfeld-Jakob disease, or BSE, however in Europe import bans or restrictions have been imposed. There is therefore a requirement for edible casings, i.e. casings which can also be consumed, which are not subject to such bans or restrictions.

Therefore edible casings have been developed which do not comprise constituents of animal origin. For instance, DE 101 29 539 discloses a casing which is produced from a mixture of cellulose, (plant) protein and a finely ground filler such as finely ground wheat bran. The protein in this case can also be crosslinked. The casing is generally produced by the amine oxide process in which the solvent used is preferably N-methylmorpholine N-oxide. The casing in principle is also suitable for bratwurst. However, it cannot be produced by coextrusion directly in sausage production.

Edible thin-walled collagen skins have also long been known. The starting material used is raw beef hides. From these the “grain split” or “flesh split” is split off in tanneries, then subjected to alkaline digestion and the digest is finally terminated by addition of acid. The alkali digest is generally carried out using sodium hydroxide solution or milk of lime. In the concluding acidification, generally a pH of below 3 is set.

The resultant “collagen rinds” are then comminuted and mixed with additives such as glycerol in a kneader. In this manner a gel-like collagen mass is produced from which tubular sausage casings can be produced by extrusion using an annular slit die. This proceeds either according to the “dry spinning process”, in which an extrusion mass having a high solids content is used, or by the “wet spinning process” in which collagen masses having a low solids fraction are used. The tubular collagen casings are generally additionally cured (see B.-A. Lang, G. Effenberger, Wursthüllen—Kunstdarm [Sausage casings—artificial skin], Deutscher Fachverlag, Frankfurt a. M., 3rd edition [2006] pp. 58-62). The production of collagen skins thereby is relatively complex. The casings cannot be produced by coextrusion immediately in sausage production.

Bratwursts having a casing based on Na alginate produced by coextrusion are already known. After the coextrusion, the readily water-soluble Na alginate is converted into slightly soluble Ca alginate by treatment with aqueous calcium hydroxide or calcium chloride solution. However, the sausage emulsion contains NaCl which, during storage of the sausages, slowly convert the Ca alginate back to Na alginate. This leads to destabilization of the casing. This process can, however, be retarded by deep freezing the sausages.

### SUMMARY OF ADVANTAGEOUS EMBODIMENTS OF THE INVENTION

The object was therefore still to produce a sausage in a seamless edible casing, wherein the casing is first provided at the moment of sausage production by coextrusion. The casing should be sufficiently mechanically stable even without drying or crosslinking by smoke. The casing in addition should be of a nature such that even on frying or grilling it retains its shape and strength (or even enhances them) and does not, for instance, melt away.

It has been found that the object can be achieved using an extrudable mass which, as important constituents, contains a non-heat-coagulating protein and also, mixed therewith, at least one heat-coagulating substance.

### DETAILED DESCRIPTION OF ADVANTAGEOUS EMBODIMENTS OF THE INVENTION

The present invention therefore relates to an edible food casing based on film-forming non-heat-coagulating protein, wherein this protein is mixed with a heat-coagulating agent.

The heat-coagulating agent is preferably a heat-coagulating protein, in particular protein from hens' eggs, blood plasma, whey isolate, globin or myosin. A mixture of a plurality of heat-coagulating proteins can also be used. It produces solidification of the casing on heating, especially on frying or grilling of the sausage. The fraction of the heat-coagulating agent is generally about 5 to 200% by weight, preferably 10 to 100% by weight, particularly preferably 20 to 75% by weight, in each case based on the weight of the non-heat-coagulating protein. The agent which coagulates on warming or heating and in this manner contributes to the strength of the casing is preferably a protein having a high fraction of lysine units and glutamic acid units. It causes solidification of the casing on frying or grilling of the sausage.

Additionally crosslinking of the casing with aldehydes or dialdehydes such as formaldehyde or glutardialdehyde, with vegetable tannins, with polyvalent ions or with liquid smoke is possible in principle, but is not necessary.

The casings according to the invention which additionally contain at least one heat-coagulating protein do not shrink until at higher temperatures as only the casings without such an addition.

The film-forming non-heat-coagulating protein is preferably edible and extrudable, particularly collagen and/or a collagen derivative such as desamido collagen. Suitable collagens are described in DE 10 2007 061 710, whose United States equivalent is found in US Patent Application Publication 2009/0162502, which is hereby incorporated by reference and is not a prior publication. Mixtures of a plurality of film-forming non-heat-coagulating proteins can also be used.

The food casing according to the invention can be produced as a flat film or else as a (preferably seamless) tubular film. In particular, it is generated by coextrusion virtually simultaneously with the production of the food product. In this case during sausage production, no casings need to be kept in store, rather they are not formed until use.

The present invention in addition relates to a food product in the preferably tubular casing according to the invention. The food with the casing is preferably a meat product, in particular sausage emulsion. Particularly preferably, the food product is a bratwurst, for example a “breakfast sausage”.

The invention also relates to a process for producing a food product in the edible casing according to the invention. The process comprises the steps:
a) providing a (co)extrudable mixture having at least one film-forming non-heat-coagulating protein and at least one heat-coagulating agent,
b) providing a pasty food which may be stuffed through a stuffing horn of a sausage stuffing machine,
c) extruding the pasty food, wherein this is enclosed, on leaving the stuffing horn, with a covering which is generated by coextrusion and is made of the mixture according to a),
d) solidifying the covering by treatment with an aqueous salt solution which precipitates out the protein, with crosslinkers, or with organic solvents, such as ethanol
e) if appropriate drying, and
f) if appropriate packing the enclosed food in a second packing, for example a film packing.

The (co)extrusion mass from which the covering or casing of the sausage is formed has an extrusion temperature of about 5° C. The dry weight fraction of film-forming non-heat-coagulating proteins and heat-coagulating agents is together about 2 to 10% by weight, preferably about 3 to 8% by weight, based on the total weight of the (co)extrusion mass.

The covering is preferably solidified using an aqueous salt solution, for example a 20% strength by weight saturated sodium chloride solution or an aqueous phosphate solution, for example a 40 to 50% strength by weight aqueous Na₂HPO₄ solution. The salt solution is expediently sprayed or poured onto the covering, immediately after it has been formed in coextrusion. In addition, the enclosed food product can additionally be passed through an appropriate salt bath. The treatment with the salt precipitates out the proteins, as a result of which the covering achieves mechanical stability. In theory the protein can also be precipitated out with (dilute) alcohol and the casing stabilized in this manner. However, this possibility is less suitable for obvious reasons.

In a subsequent, further aqueous bath (or else combined with the salt solution, if the pH of the salt solution is suitable therefor), a treatment with transglutaminase can proceed. This enzymatic treatment with transglutaminase causes a crosslinking of the protein molecules which likewise makes the covering more mechanically stable. Mixing the transaminase directly with the extrusion mass has proved to be less expedient. Crosslinking then usually proceeds too quickly so that the mass can no longer be extruded homogeneously.

If the casing is produced by (co)extrusion using a ring die, it is also seamless. However, flat films may also be produced. For this, the mixture having one (or more) film-forming, non-heat-coagulating protein and one (or more) heat-coagulating agents is poured or spread for example onto a suitable support (in the simplest case this can be a glass plate) in the form of a layer as uniform as possible. Excess water is then pressed off. After solidification, in particular in the above described manner using a salt solution, the film may be detached from the support.

The food product (e.g. bratwurst) in the casing produced according to the invention by coextrusion is expediently produced “in an endless” manner and then separated into individual sausages, e.g. using what is termed displacing shears. Sealing or twisting off the casing between the individual sausages produced in this process or even the application of wire or plastic clips is not necessary.

If appropriate, the food product having the enclosing solidified casing is dried, generally with air, of no more than about 30° C.

The enclosed food product is intended, in particular, for being heated by the end user to a temperature at which heat coagulation begins in the casing. In particular, the food product is a “breakfast sausage” widespread in Britain and the USA. Since this sausage type is not smoked and heated on the part of the manufacturer, the casing remains colorless and transparent, and so the emulsion may be seen.

If appropriate, food dyes (e.g. E120, cochineal, a red dye as per Color Index No. 75470) can be admixed to the extrusion mass, for example in the production of “Røde Pølser”, a special type of hot dog widespread in Scandinavia.

In principle, standard hot dogs can also be produced in the above described manner. In this case the casing is then further crosslinked with liquid smoke (wherein the casing is colored brown to reddish-brown). The hot dogs are customarily dried at elevated temperature (about 80° C.).

In addition to, or instead of, film-forming, non-heat-coagulating protein, if appropriate, a polysaccharide, especially alginate, can also be used. The alginate casings described at the outset also may be stabilized by addition of heat-coagulating agents, in particular heat-coagulating proteins.

The example hereinafter serves to illustrate the invention. Percentages are taken to mean percentages by weight therein, unless otherwise stated or is immediately clear from the context.

### EXAMPLE

An aqueous extrudable mass was produced from 680 ml of water, 200 g of ice, 100 g of a 40% strength by weight collagen mass and 20 g of blood plasma powder (the pH was set to about 2.5 to 3.0 in this case using acetic and lactic acids). After swelling for several hours, it was homogenized, degassed and fed to the coextrusion die of a sausage stuffing machine. Bratwurst emulsion was enclosed, on exit from the stuffing horn of the stuffing machine, by a continuous seamless coating of the extrusion mass. Immediately after formation of the coating, 40% strength by weight of potassium dihydrogenphosphate solution was poured over it and was thus solidified. The thus encased bratwurst was then dried with air at about room temperature until the surface was essentially dry.

On frying or else grilling, the casing remained intact. It had bound internally to the sausage emulsion. The bratwurst met all conventional criteria, and in particular the casing was very readily chewable.

That which is claimed:

1. An edible food casing comprising at least one film-forming non-heat-coagulating protein, wherein said protein is mixed with at least one heat-coagulating agent.

2. The food casing as claimed in claim 1, wherein the heat-coagulating agent is a heat-coagulating protein.

3. The food casing as claimed in claim 1, wherein the non-heat-coagulating protein is an edible, extrudable collagen and/or a collagen derivative.

4. The food casing as claimed in claim 1, wherein the heat-coagulating protein contains lysine units and glutamic acid units.

5. The food casing as claimed in claim 1, wherein said casing further optionally contains polysaccharide and the fraction of the heat-coagulating agent is 5 to 200% by weight, based on the weight of the non-heat-coagulating protein and optional polysaccharide.

6. The food casing as claimed in claim 1, wherein said food casing is tubular.

7. A food product comprising a casing as claimed in claim 1 enclosing the food.

8. A process for producing a food product as claimed in claim 7 having a seamless tubular casing, said process comprising
a) providing a (co)extrudable mixture having at least one film-forming non-heat-coagulating protein and at least one heat-coagulating agent,
b) providing a pasty food and extruding the provided pasty food through a stuffing horn of a sausage stuffing machine,
c) enclosing the extruded pasty food, on leaving the stuffing horn, by coextruding a covering onto the extruded pasty food, said covering comprising the mixture according to a),
d) solidifying the covering by treatment with an aqueous salt solution that precipitates out the protein, with crosslinkers, or with organic solvents,
e) optionally drying, and
f) optionally packing the enclosed food in a second packing.

9. The process as claimed in claim 8, wherein the (co)extrudable mixture has a dry weight fraction of 2 to 10% by weight of film-forming non-heat-coagulating protein and heat-coagulating agents together.

10. The process as claimed in claim 8, wherein said solidifying comprises treatment with an aqueous salt solution that precipitates out the protein, said treatment further comprising spraying or pouring the aqueous salt solution onto the covering of the food product immediately after coextruding the covering.

11. The process as claimed in claim 10, wherein the food product is treated with an aqueous transaminase solution after said food product has been treated with the aqueous salt solution.

12. The process as claimed in claim 10, wherein the food product is treated with an aqueous salt solution which additionally contains transaminase.

13. The process as claimed in claim 8, wherein the aqueous salt solution is an aqueous sodium chloride solution or an aqueous sodium or potassium phosphate solution.

14. The process as claimed in claim 8, wherein said drying comprises drying with air having a temperature of 30° C. or below.

15. Artificial sausage casing comprising the food casing as claimed in claim 1.

16. The food casing as claimed in claim 2, wherein the heat-coagulating agent comprises protein from hens' eggs, blood plasma, whey isolate, globin, myosin or a mixture thereof.

17. The food casing as claimed in claim 5, wherein the fraction of the heat-coagulating agent 10 to 100% by weight, based on the weight of the non-heat-coagulating protein and optional polysaccharide.

18. The food casing as claimed in claim 5, wherein the fraction of the heat-coagulating agent is 20 to 75% by weight, based on the weight of the non-heat-coagulating protein and optional polysaccharide.

19. The food casing as claimed in claim 6, wherein said casing is seamless.

20. The process as claimed in claim 8, wherein said second packing comprises a film packing.

21. The process as claimed in claim 9, wherein the coextrudable mixture has a dry weight fraction of about 3 to 8% by weight of film-forming non-heat-coagulating protein and heat-coagulating agents together.

22. An artificial sausage casing as claimed in claim 15, wherein said sausage is bratwurst.

23. An edible food casing comprising one or more of (i) at least one film-forming non-heat-coagulating protein and (ii) polysaccharide, wherein said protein and/or polysaccharide is mixed with at least one heat-coagulating agent.
